(19) United States
(12) Patent Application Publication
(10) Pub. No.: US 2026/0289056 A1
(43) Pub. Date: Sep. 24, 2026

(54) Board thermal dissemination simulation method, system and medium

(71) Applicant: XPEEDIC CO., LTD., Shanghai (CN)

(72) Inventors: Wenliang DAI, Shanghai (CN); Feng LING, Shanghai (CN); Peng LIU, Shanghai (CN); Liguo JIANG, Shanghai (CN); Zhangmin ZHONG, Shanghai (CN)

(73) Assignee: XPEEDIC CO., LTD., Shanghai (CN)

(21) Appl. No.: 18/998,489

(22) PCT Filed: Apr. 6, 2023
(86) PCT No.: PCT/CN2023/086539

§ 371 Date: Nov. 11, 2025

(30) Foreign Application Priority Data
Oct. 21, 2022 (CN) 2022112905517

(51) Int. Cl. G06F 30/32

(52) U.S. Cl. CPC G06F 30/32

(57) ABSTRACT

A board thermal dissemination simulation method, comprising: introducing a simulation model; creating a thermal dissemination simulation process; proceeding with simulation analysis; where no thermal dissemination risk is detected during simulation, thermal dissemination is sufficient; where a thermal dissemination risk is detected during simulation, reserving simulation results and the simulation process corresponding to the simulation results, and modifying model patterns on a basis of original simulation model; and repeating steps S2 to S4 in the modified model pattern, until the simulation results show that thermal dissemination is sufficient. In the present invention, without making actual product, by simulation analysis of an introduced simulation model, thermal dissemination risks of the product in different running conditions is obtained and technological development time and sampling expenses required are saved to a great extent.

### TECHNICAL FIELD

The present invention belongs to the technical field of EDA model layout simulation, specifically, a board thermal dissemination simulation method, system and medium.

### BACKGROUND TECHNOLOGY

Printed circuit boards (PCBs) are bridges for connecting electronic devices and components and connection circuits, as “mother of electronic components”, the PCBs have been widely used in the fields such as communication, consumer electronics, computers, automotive electronics, industrial control, medical apparatuses, national defense and cosmonautics, and are a kind of electronic component indispensible in modern electronic information products. With the rapid technological development, especially the high-speed development of semi-conductors, demands on electronic devices on PCBs are rising significantly. What's more, with the wide application of integrated circuits, the electronic devices are growing smaller and smaller, wiring density and difficulties for circuits are increasing too, the PCBs have developed from single-sided to double-sided, multi-layer and flexible boards; and structures and quality thereof have developed toward ultra-high density and micro-size, which requires the PCBs have high electric reliability, thermal reliability and structural reliability. If thermal dissemination of the PCBs is not efficiently designed, the reliability and service life of electronic devices will be directly affected. For conventional PCB detection methods design drawings and board making are required, and subsequently thermal dissemination risks in specific environment will be evaluated by experimental measurement, such thermal analysis methods consume time significantly, and involve high expenses, usually repeated iteration is required in order to obtain satisfactory results, which poses a huge challenge to manpower, physical resources and time expenses. As an instance, for the board thermal dissemination simulation system, usually equivalent models are used to simulate the laminated structures of the PCBs, while components on boards are reduced, the simulation accuracy is compromised, however, by introducing EDA models, the models can be restored to improve simulation accuracy, however, the software is not entitled to modify or edit the PCBs, and users cannot edit or modify the details of the models according to feedbacks of the simulation results (for example, laminated heights, dimensions and heights of soldering balls, types of vias and initial positions etc.) in order to adjust the design solution quickly and obtain the verified results. Further, for many common board thermal dissemination simulation systems, the number of thermal dissemination simulation processes in the system is limited, and the simulation program can only start a thermal dissemination simulation process. After completing one thermal dissemination simulation analysis, if another simulation verification based on the simulation results is desired, the current settings shall be modified which results in lapse of the current simulation results, and thermal dissemination simulation analysis and result comparison in the system cannot be carried out. Therefore an economic, efficient and quick thermal analysis means for evaluating thermal dissemination risk of electronic devices is urgently in need.

A Chinese patent application number CN202111520360 disclosed on Mar. 25 2022, disclosed a method, system, medium and device for PCB hot spot detection and thermal dissemination simulation, comprising: step 1: building a PCB model, and introducing the same to an EDA simulation software; step 2: setting parameters of a working environment of the PCB in the EDA simulation software; step 3: setting boundary conditions of the PCB during convergence, and converging; step 4: generating meshes for the convergence results, setting the simulation accuracy, and simulating; step 5: comparing and analyzing the simulation results; and step 6: quantifying the analysis results, when the preset condition is met, going on with the PCB production otherwise improving the PCB layout, and returning to step 1 to continue. The deficiency of the patent application is that: the entire flow process is very long, which makes it difficult to compare results in two adjacent analyses.

Another Chinese patent application CN2019105551431 disclosed on Sep. 24 2019 disclosed a method for optimizing the heat radiators of power devices, comprising: A1: creating a three-dimensional simulation model of an IGBT module and a heat radiator; A2: setting the boundary conditions of the three-dimensional simulation model, and the boundary conditions comprise thermal energy loss power and environment temperature of the IGBT module; A3: outputting the calculation results of the three-dimensional simulation model according to the thermal resistance judgment method, and the calculation results comprise temperature distribution cloud picture of a horizontal surface of the heat radiator, and a temperature distribution cloud picture of a vertical cross section of the heat radiator; A4: adjusting structures and dimensions of the heat radiator, repeating steps A1~A3, comparing the thermal dissemination effects of heat radiators of different sizes and obtaining a structural dimension of the optimal heat radiator. The deficiency of the patent application lies in that: the time expense is high when new models are continuously built.

### SUMMARY OF THE INVENTION

### 1. The Problems to Be Solved

In view of the problem that the PCB thermal dissemination simulation is time consuming and involves high expenses, the present invention provides a board thermal dissemination simulation method, system and medium. Without making actual products, the present invention makes simulation analysis to the introduced simulation model, which saves development time and cost associated with sample preparation; and it is also possible to modify the model according to the current results, which eliminates repeated work and accelerates the development speed. The system in the present invention is structurally simple while stably working.

### 2. Technical Solutions

To overcome the foregoing problem, the present invention proposes the following technical solution:

A board thermal dissemination simulation method, comprising:
S1: importing a simulation model;
S2: creating a thermal dissemination simulation process;
S3: proceeding with simulation analysis;
S4: where no thermal dissemination risk is detected during simulation, thermal dissemination is sufficient; where a thermal dissemination risk is detected during simulation, reserving simulation results and the simulation process corresponding to the simulation results, and modifying model layouts on a basis of the original simulation model; and
S5: repeating steps S2 to S4 in the modified model layout, until the simulation results show that thermal dissemination is sufficient.

Further, in the step S4, modifying the model layout comprising any one or combination of: adding or deleting a conductor layer or a medium layer in a multilayer PCB laminated structure; and modifying a thickness of the conductor layer or the medium layer in the PCB laminated structure.

Further, modifying the model layout in the step S4 comprises any one or combination of: adding or deleting at least one via in the PCB; modifying a position of a starting layer and a terminating layer of the at least one via; modifying a diameter of the at least one via and changing a thickness of conductors attached in the at least one via; modifying shapes and contours of the at least one via; and modifying a size of a gap between the at least one via and layers of the PCB laminated structure.

Further, the step S3 comprises specifically:
S31: completing parameter setting for thermal source appliances in the simulation model: parameter setting comprises defining dimensions, attributes, power distribution and thermal disseminators of the thermal source appliances;
S32: setting simulation environments: setting thermal convection in the simulation environments; placement of the simulation model; and convective heat transfer coefficients and temperature boundary conditions during heat transfer; and
S33: going on with simulation analysis.

Further, in the simulation analysis in the step S33, current analysis information, analysis progress, and status analysis outcome, error information and analysis reports can be presented in a visualized form.

Further, the method further comprises a step S6: comparing the simulation results: by calling different simulation results and the simulation processes corresponding to the simulation results, an optimum thermal design solution of the PCB layout upon modification of the model layout can be obtained.

A system using the board thermal dissemination method as defined in the foregoing paragraphs, comprising:

An importation module: configured to import a simulation model;

A creation module: configured to create a thermal dissemination simulation process;

An analysis module: configured to analyze a simulation model;

A result module: configured to display analysis results;

An adjusting module: configured to modify a model layout; and

A storage module: configured to store the simulation results and the simulation processes corresponding to the simulation results.

A computer readable storage medium where a computer program is stored, and the computer program when being executed by a processor will have a processor execute the board thermal dissemination simulation method as defined in the foregoing paragraphs.

### 3. Beneficial Effects

Compared with the prior art, the beneficial effects of the present invention are:
(1) In the present invention, without making actual product, by simulation analysis of an introduced simulation model, thermal dissemination risks of the product in different running conditions is obtained so as to judge whether the thermal dissemination plan of the product is sufficient, and technological development time and sampling expenses required are saved to a great extent; in the meanwhile, where thermal dissemination risks exist, the layout of the original model can be modified according to the present results, design iteration and data interaction of design and manufacturing of the PCBs in different stages and software is reduced, generation of a large amount of repeated work is avoided, the development is accelerated, manpower and time expenses required for development of electronic products is further reduced, and commercial values of the electronic products are significantly improved;
(2) In the present invention, by detailed layout modification, changing the number of layers or thicknesses of the conductor layers or the medium layers in the PCT laminated structure, changing the types of vias in the PCBs and positions and dimensions thereof and by detailed variations from a variety of perspectives and directions, finally upon iteration verification the thermal dissemination requirements have been met, strong supports are provided for subsequent thermal dissemination design, proper thermal dissemination solutions for the PCBs can be obtained quickly and the technological development efficiency can be effectively improved; and
(3) In the present invention, by reserving different simulation results and simulation processes corresponding to the simulation results, it is convenient to call and check the simulation results, compare the temperature distribution and temperature rise changes due to different modifications to the model layouts, and the problem of time consumption required for multiple result comparison and analysis in the past is avoided; in the meanwhile, temperature changes due to different modifications to the model layouts can be appreciated by the designers conveniently so as to arrive at the optimum design solution and the development efficiency is greatly improved; and
(4) The system provided in the present invention is of a simple structure, the modules are working closely while independently; with the present system, quick verification of thermal design of the layout can be realized, repeated work for repeated iteration of design and verification is simplified, and the development speed of the electronic products can be accelerated.

### BRIEF DESCRIPTION OF DRAWINGS

FIG. 1 is a schematic diagram showing a flow process of the present invention.

### EMBODIMENTS

Hereinafter a further description will be given to the present invention with reference to the embodiments and the drawings.

### Embodiment 1

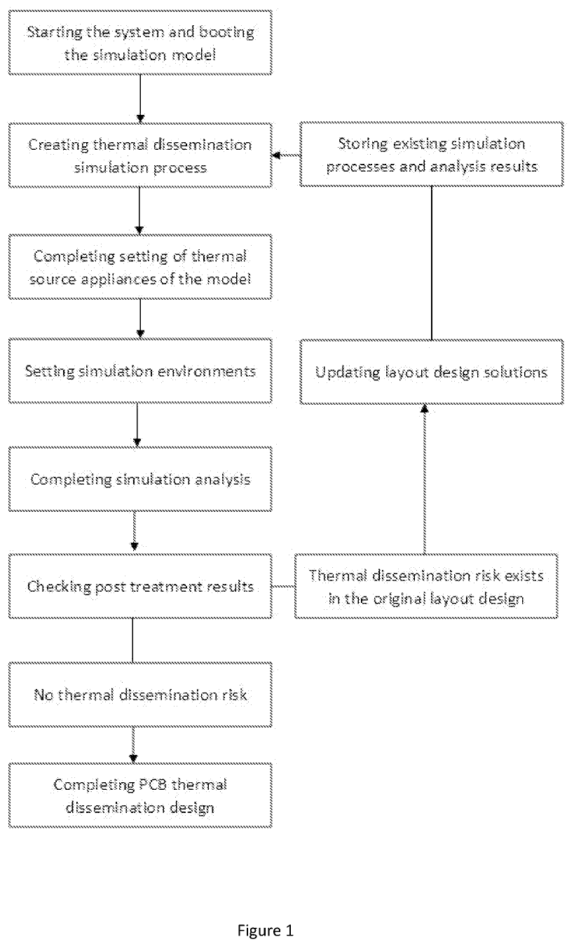

As shown in FIG. 1, a board thermal dissemination simulation method, comprising:
S1: introducing a simulation model; specifically, introducing the simulation model for PCBs in the present step, and displaying completely detailed layout of the simulation model of the PCBs during introduction, meanwhile, extracting lamination information, material information, appliance information and via information of the simulation model;
S2: creating a thermal dissemination simulation process; in the present step, selecting a Thermal simulation process and creating the process, which supports a plurality of simulation analysis, for example, signal transmission, power transmission, model extraction etc. ; it shall be noted that: the Thermal simulation process is a simulation process specially target at thermal dissemination analysis, having a high compatibility and accuracy; it has consistent simulation processes as mainstream simulation processes, which will not be repeated here; during creating the thermal dissemination simulation process, steps to be completed in the process will be shown, a state identifier for each of the steps will be used to indicate whether setting of the step is done, so as to improve visualization of the entire process; and it shall be explained that, a plurality of Thermal simulation processes can be created in the same project, and display of each of the processes can be selected freely and setting information and simulation results thereof will be displayed;
S3: going with simulation analysis; and the present step comprises the following steps:
S31: completing parameter setting for thermal source appliances in the simulation model: parameter setting comprises defining dimensions, attributes, power distribution and thermal disseminators of the thermal source appliances;
S32: setting the simulation environments: setting thermal convective types in the simulation environment; placement of the simulation model; and convective heat transfer coefficients and temperature boundary conditions during heat transfer;
S33: going on with specific simulation analysis; in the present step, during simulation analysis, the current analysis information, the analysis progress, the status analysis after analysis, error information and the analysis reports can be shown in a visualized manner, so as to make it convenient for researchers to know the progress and be acquainted with the current status in order to improve the working efficiency;
S4: where no thermal dissemination risk is shown according to the simulation results, the thermal dissemination is qualified; where a thermal dissemination risk is detected according to the simulation results, storing the simulation results and the simulation processes corresponding to the simulation results, and modifying the model layouts on the basis of the original simulation model; the simulation results are shown as followings: layered temperature cloud images, integral temperature cloud images, sectional temperature cloud images and extreme temperature points; judging whether the thermal dissemination risk exists according to the foregoing information, judging global and local thermal dissemination risk according to the temperature cloud images from different perspectives to judge comprehensively and improve accuracy of the judgment results;

Specifically, modifying the model layouts comprises any one or combination of: adding or deleting a conductor layer or a medium layer in the multilayer PCB laminated structure; modifying a thickness of the conductor layer or the medium layer in the PCB laminated structure, and judging the temperature distribution and temperature rise change of the current model after change of the number of layers in subsequent simulation analyses; or adding or deleting vias in the PCBs; modifying positions of initiating layers and terminating layers of the vias; modifying diameters of the vias and changing thicknesses of the conductive materials attached in the vias; modifying the shapes and contours of the vias; modifying sizes of gaps between the PCB laminated structure and the layers where the vias are located, and judging the temperature distribution and temperature rise changes after changes of the vias of the current model in subsequent simulation analyses; by modifying the model layout in two directions and details in each of the two directions, and detailed modifications from different perspectives and directions, finally by iterative verification, thermal dissemination requirements are met, and strong supports are provided for proper subsequent thermal dissemination solution, which makes it convenient to obtain the thermal dissemination solution of the PCBs quickly and improve effectively technological development efficiency;
S5: repeating steps S2 to S4 according to the modified model layouts, until the simulation results are acceptable; judging where the problem is according to the temperature results in the step S4, optimizing the layout design on the basis of the original model, modifying corresponding parameters and creating again the thermal dissemination simulation process, conducting simulation analysis subsequently, obtaining the simulation results, repeating the steps S2 to S4 until finally the thermal dissemination requirements are met.

In the present invention, without making actual product, by simulation analysis of an introduced simulation model, thermal dissemination risks of the product in different running conditions is obtained so as to judge whether the thermal dissemination plan of the product is sufficient, and technological development time and sampling expenses required are saved to a great extent; in the meanwhile, where thermal dissemination risks exist, the layout of the original model can be modified according to the present results, design iteration and data interaction of design and manufacturing of the PCBs in different stages and software is reduced, generation of a large amount of repeated work is avoided, the development is accelerated, manpower and time expenses required for development of electronic products is further reduced, and commercial values of the electronic products are significantly improved.

Further, the present embodiment further comprises a step S6: comparing simulation results: by calling different simulation results and the simulation processes corresponding to the simulation results, obtaining an optimum thermal design solution of the PCB layouts upon modifications of one or more model layouts; in the present step, by comparing the results of different simulation processes, thermal dissemination effects of different thermal design solution can be verified; in the prior art, where details of the layout are modified, the temperature results cannot be displayed after running the modified solution, that is, by starting a project, only one analysis can be done, in order to make multiple analyses, a plurality of programs are to be started; however, in the present invention, by enabling creating a plurality of Thermal simulation processes in the same engineering file, a plurality of thermal simulation analyses are supported, each of the analyses exists individually after completion without influencing the completed analysis results, neither influencing subsequent analyses, multiple results can be called for review and comparison, the development efficiency is improved to a significant extent.

### Embodiment 2

A system employing the board thermal dissemination simulation method as recited above, comprising:
An introduction module: configured to introduce a simulation model; specifically, the introduction module supports a plurality of models, during introduction, the network information to be introduced can be selected, after introduction, detailed layouts of the model pattern is shown, comprising Trace, Pad, Drill, Shape, Component and Solderball etc.; in the meanwhile, extracting lamination information, material information, appliance information and via information of the model and displaying in corresponding windows;
A creating module: configured to create a thermal simulation process; selecting the Thermal simulation process and creating the process in the creating module, and in the present module, by an analysisset module, creation of a plurality of Thermal simulation processes in the same project is allowed, and while the present verification results are stored, a new thermal dissemination simulation process is set for modified design solutions, the Thermal simulation processes can be freely selected and setting information and simulation results can be displayed;
An analysis module: configured to analyze the simulation module; in the present module, setting of the thermal source appliances in the model, setting of the simulation environment and completing simulation analysis is done;
A result module: configured to display the analysis results;
An adjusting module: configured to modify the model layout; in the present module, adding or deleting the layers of the multilayer PCBs by a stackup module and modifying the thicknesses of the layers of the PCB laminated structure is allowed; adding or deleting the vias in the PCBs by a Padstack module, modifying positions of the initiating layers and the terminating layers of the vias, modifying the diameters of the vias, changing the thicknesses of the conductive material in the vias, modifying the shapes and contours of the vias, and modifying the dimensions of the gaps where the vias pass the layers of the PCB laminated structure is allowed so as to modify the model layout;
A storage module: configured to store the simulation results and the simulation processes corresponding to the simulation results; making it convenient to call the temperature results of the thermal dissemination simulation processes for comparison, verifying the thermal dissemination effects of different design solutions, and obtaining the optimum thermal design solution, reducing interactions between pattern design and simulation and improving product development efficiency.

With the system provided in the present invention, interactive design during simulation and design is achieved, that is, by adjusting in real time according to the simulation results, calling the simulation results to check whether thermal dissemination requirements are met after adjusting, finally by iterative verification thermal dissemination requirements are met. With the entire system, quick verification of the thermal design solution of the layout can be realized, repeated iterative work between design and verification is simplified and development of electronic products is accelerated.

### Embodiment 3

A computer readable storage medium where a computer program is stored, and the computer program when being executed by a processor will have a processor execute the board thermal dissemination simulation method as defined in the embodiment 1. It is worth noting that for those skilled in the art, in addition to implementing the system and various modules provided by the present application in a purely computer-readable program code, it is entirely possible to implement the same program in the form of logic gates, switches, application-specific integrated circuits, editable logic controllers, and embedded microcontrollers by logically programming the method steps. Therefore, the system and its various modules provided by the present application can be considered as a hardware component, and the modules included therein for implementing various programs can also be regarded as structures within the hardware component, and the modules for implementing various functions can also be regarded as software programs for implementing the method and structures or the hardware component.

The embodiments in the present invention are used to describe the preferred embodiments of the present invention instead of limiting the essence and the scope of the present invention, without departing from the essence of the present invention, all variations and improvements those skilled in the art made shall fall into the protection scope of the present invention.

1. A board thermal dissemination simulation method, comprising:
S1: importing a simulation model;
S2: creating a thermal dissemination simulation process;
S3: proceeding with simulation analysis;
S4: where no thermal dissemination risk is detected during simulation, thermal dissemination is sufficient; where a thermal dissemination risk is detected during simulation, reserving simulation results and the simulation process corresponding to the simulation results, and modifying a model layout on a basis of original simulation model; and
S5: repeating steps S2 to S4 in the modified model layout, until the simulation results show that thermal dissemination is sufficient.

2. The board thermal dissemination simulation method according to claim 1, wherein in the step S4, modifying the model layout comprising any one or combination of: adding or deleting a conductor layer or a medium layer in a multilayer PCB laminated structure; and modifying a thickness of the conductor layer or the medium layer in the PCB laminated structure.

3. The board thermal dissemination simulation method according to claim 1, wherein modifying the model layout in the step S4 comprises any one or combination of: adding or deleting at least one via in the PCB; modifying a position of a starting layer and a terminating layer of the at least one via; modifying a diameter of the at least one via and changing a thickness of conductors attached in the at least one via; modifying shapes and contours of the at least one via; and modifying a size of a gap between the at least one via and layers of the PCB laminated structure.

4. The board thermal dissemination simulation method according to claim 1, wherein the step S3 comprises specifically:
S31: completing parameter setting for thermal source appliances in the simulation model: parameter setting comprises defining dimensions, attributes, power distribution and thermal disseminators of the thermal source appliances;
S32: setting simulation environments: setting thermal convection in the simulation environments; placement of the simulation model; and convective heat transfer coefficients and temperature boundary conditions during heat transfer; and
S33: going on with simulation analysis.

5. The board thermal dissemination simulation method according to claim 4, wherein in the simulation analysis in the step S33, current analysis information, analysis progress, and status analysis outcome, error information and analysis reports are presented in a visualized form.

6. The board thermal dissemination simulation method according to claim 1, wherein the method further comprises a step S6: comparing the simulation results: by calling different simulation results and the simulation processes corresponding to the simulation results, obtaining an optimum thermal design solution of the PCB layout upon modification of the model layout.

7. A system using the board thermal dissemination method as defined in claim 1, comprising:
an importation module: configured to import a simulation model;
a creation module: configured to create a thermal dissemination simulation process;
an analysis module: configured to analyze a simulation model;
a result module: configured to display analysis results;
an adjusting module: configured to modify a model layout; and
a storage module: configured to store the simulation results and the simulation processes corresponding to the simulation results.

8. A computer readable storage medium where a computer program is stored, and the computer program when being executed by a processor will have a processor execute the board thermal dissemination simulation method as defined in any of claim 1.
